(19) United States
(12) Patent Application Publication
(10) Pub. No.: US 2026/0136144 A1
(43) Pub. Date: May 14, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Yuta Shimotsuma, Osaka (JP); Motoshi Anabuki, Hyogo (JP); Stephen William John, Nara (JP); Shunsuke Kuhara, Osaka (JP); Masashi Otani, Osaka (JP)

(21) Appl. No.: 19/443,284

(22) Filed: Jan. 8, 2026

Related U.S. Application Data
(63) Continuation of application No. PCT/JP2024/025256, filed on Jul. 12, 2024.

(30) Foreign Application Priority Data
Jul. 24, 2023 (JP) 2023-120191

(51) Int. Cl. H04R 29/00

(52) U.S. Cl. CPC H04R 29/001; H04R 2499/13

(57) ABSTRACT

An information processing method according to an aspect of the present disclosure includes: detecting a sound output from a first speaker included in a mobile object; and determining whether the sound output from the first speaker is a predetermined sound based on the result of the detecting of the sound output from the first speaker.

### CROSS REFERENCE TO RELATED APPLICATIONS

This is a continuation application of PCT International Application No. PCT/JP2024/025256 filed on Jul. 12, 2024, designating the United States of America, which is based on and claims priority of Japanese Patent Application No. 2023-120191 filed on Jul. 24, 2023. The entire disclosures of the above-identified applications, including the specifications, drawings and claims are incorporated herein by reference in their entirety.

### FIELD

The present disclosure relates to an information processing method, an information processing device, and a recoding medium.

### BACKGROUND

Conventionally, a device is provided which is installed in a vehicle such as a self-driving vehicle, and outputs a warning sound. For example, the device can alert a vehicle or a target located around the vehicle by outputting a warning sound. For example, Patent Literature (PTL) 1 discloses a control device which controls a self-driving vehicle including a device for outputting a warning sound. The control device disclosed in PTL 1 performs control to prevent the self-driving vehicle from switching to a travel mode when the warning sound output device is anomalous.

### CITATION LIST

### Patent Literature

PTL 1: Japanese Unexamined Patent Application Publication No. 2023-30329

### SUMMARY

### Technical Problem

Here, for example, it is assumed that a device such as a speaker for outputting a warning sound is faulty. In such a case, there is a possibility that a warning sound is not output, and thus a target such as a pedestrian cannot be alerted. Even when a sound is output from a speaker, there is a possibility that the target cannot be sufficiently alerted due to the influence of noise or the like. As described above, there is a possibility that an appropriate sound is not output from the speaker.

The present disclosure provides an information processing method and the like which can determine whether an appropriate sound is output from a speaker.

### Solution to Problem

An information processing method according to an aspect of the present disclosure includes: detecting a sound output from a first speaker included in a mobile object; and determining whether the sound output from the first speaker is a predetermined sound based on a result of the detecting of the sound output from the first speaker.

An information processing device according to an aspect of the present disclosure includes: a detector that detects a sound output from a first speaker included in a mobile object; and a determiner that determines whether the sound output from the first speaker is a predetermined sound based on a result of the detecting of the sound output from the first speaker.

A recoding medium according to an aspect of the present disclosure is a non-transitory computer-readable recording medium having recorded thereon a program for causing a computer to execute the information processing method described above.

### Advantageous Effects

According to the present disclosure, it is possible to provide an information processing method and the like which can determine whether an appropriate sound is output from a speaker.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing the configuration of an anomaly detection system in Embodiment 1.

FIG. 2 is a block diagram showing the configuration of a terminal in Embodiment 1.

FIG. 3 is a diagram for illustrating anomaly detection processing performed by the terminal in Embodiment 1.

FIG. 4 is a diagram showing specific examples of a measure performed by the terminal in Embodiment 1.

FIG. 5 is a sequence diagram showing the processing procedure of the anomaly detection system in Embodiment 1.

FIG. 6 is a flowchart showing the processing procedure of the anomaly detection processing performed by the terminal in Embodiment 1.

FIG. 7 is a block diagram showing the configuration of a terminal in Embodiment 2.

FIG. 8 is a diagram showing a specific example of an image displayed on a display device included in a PC in Embodiment 2.

FIG. 9 is a flowchart showing the processing procedure of the terminal in Embodiment 2.

FIG. 10 is a block diagram showing the configuration of an anomaly detection system in Variation 1.

FIG. 11 is a block diagram showing the configuration of an anomaly detection system in Variation 2.

FIG. 12 is a flowchart showing the processing procedure of an information processing device according to an aspect of the present disclosure.

### DESCRIPTION OF EMBODIMENTS

Embodiments will be described below with reference to drawings. The embodiments described below indicate general or specific examples. Numerical values, shapes, materials, constituent elements, the arrangement and connection of the constituent elements, steps, the order of the steps, and the like shown in the following embodiments are examples, and are not intended to limit the present disclosure. Among the constituent elements in the following embodiments, constituent elements which are not recited in the independent claims are described as optional constituent elements.

The drawings are schematic views, and are not exactly shown. Hence, for example, the scales and the like of the drawings do not necessarily match each other. In the drawings, substantially the same configurations are identified with the same reference signs, and repeated description may be omitted or simplified.

### Embodiment 1

### [Configuration]

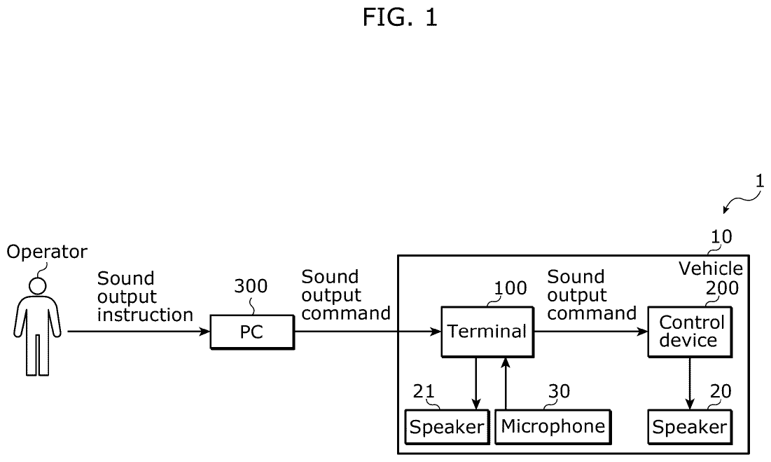

FIG. 1 is a block diagram showing the configuration of anomaly detection system 1 in the present embodiment.

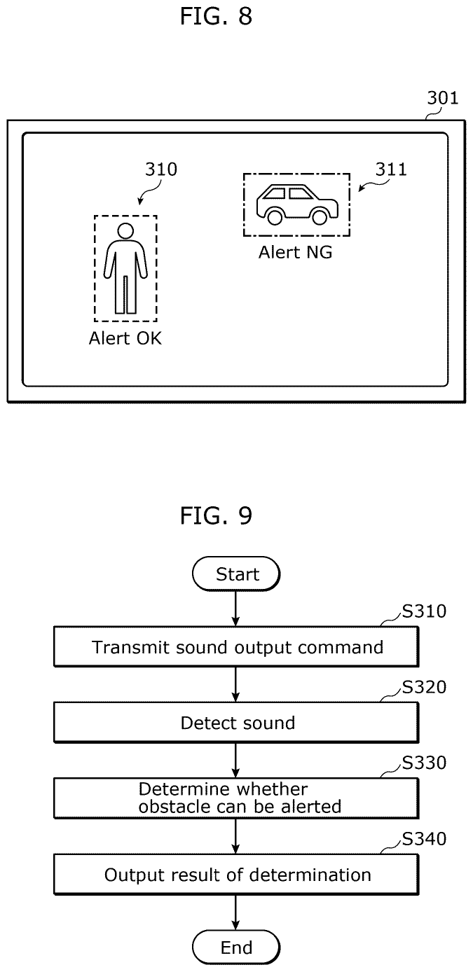

Anomaly detection system 1 is a system which detects whether an appropriate sound is output from speaker 20 included in vehicle 10. For example, anomaly detection system 1 detects whether an appropriate sound is output from speaker 20 which outputs a sound based on a command (sound output command) output from PC 300 operated by an operator and is included in vehicle 10. In anomaly detection system 1, for example, the operator checks information from a sensor such as a camera included in vehicle 10 to remotely monitor or remotely control vehicle 10. For example, the operator operates operation devices such as a steering wheel and a brake which are not shown in the figure while checking an image displayed on a display device (for example, display device 301 shown in FIG. 8) such as a display included in PC 300. PC 300 transmits information related to an operation received by the operation device to control device 200. In this way, control device 200 controls vehicle 10 based on the operation performed by the operator.

The operator operates PC 300 to transmit the sound output command to control device 200 which controls vehicle 10 via terminal 100. Control device 200 which acquires the sound output command causes speaker 20 to output a sound corresponding to the sound output command. Here, terminal 100 determines whether the sound corresponding to the sound output command is output from speaker 20.

The sound output by speaker 20 is not limited to the sound corresponding to the sound output command. For example, the sound output by speaker 20 may be a voice which is output by the operator or an output sound which is automatically produced by vehicle 10. In other words, terminal 100 may determine whether the output sound automatically produced by vehicle 10 is appropriately output from speaker 20.

In the following description, the output of a sound by a speaker is also referred to as sound output.

Anomaly detection system 1 includes vehicle 10, terminal 100, speaker 21, microphone 30, and PC 300.

Vehicle 10 is a vehicle which is remotely monitored and/or remotely controlled by the operator. Vehicle 10 may be a self-driving vehicle which performs self-driving, may be a vehicle which is remotely controlled by the operator, or may be a vehicle which is driven by a driver in vehicle 10.

Vehicle 10 is an example of a mobile object.

One vehicle 10 may be included in anomaly detection system 1 or a plurality of vehicles 10 may be included in anomaly detection system 1.

Vehicle 10 includes control device 200 and speaker 20.

Control device 200 is a computer which controls the operation of vehicle 10. Control device 200 includes, for example, a communication interface for communicating with each device, a nonvolatile memory in which a program is stored, a volatile memory which is a temporary storage region for executing the program, an input/output port for transmitting and receiving signals, a processor for executing the program, and the like. The communication interface may be realized by a connector or the like connected to a control line for wired communication with terminal 100, or may be realized by a wireless communication circuit for wireless communication with terminal 100.

For example, when control device 200 acquires the sound output command, control device 200 causes speaker 20 to output the sound corresponding to the sound output command.

Speaker 20 is a speaker which outputs a sound. Speaker 20 is disposed in, for example, vehicle 10 to output a sound to around vehicle 10. Speaker 20 is an example of a first speaker.

Terminal 100 is a computer which acquires the sound output command output from PC 300, and outputs (transfers) the sound output command to control device 200. Terminal 100 includes, for example, a communication interface for communicating with each device, a nonvolatile memory in which a program is stored, a volatile memory which is a temporary storage region for executing the program, an input/output port for transmitting and receiving signals, a processor for executing the program, and the like. The communication interface may be realized by a wireless communication circuit or the like for wireless communication with PC 300. In the present embodiment, terminal 100 is disposed in vehicle 10. Terminal 100 may include a communication interface which is realized by a connector or the like connected to a control line for wired communication with control device 200.

Terminal 100 may be disposed outside vehicle 10. Terminal 100 may include a wireless communication circuit or the like for wireless communication with control device 200.

Terminal 100 is an example of an information processing device.

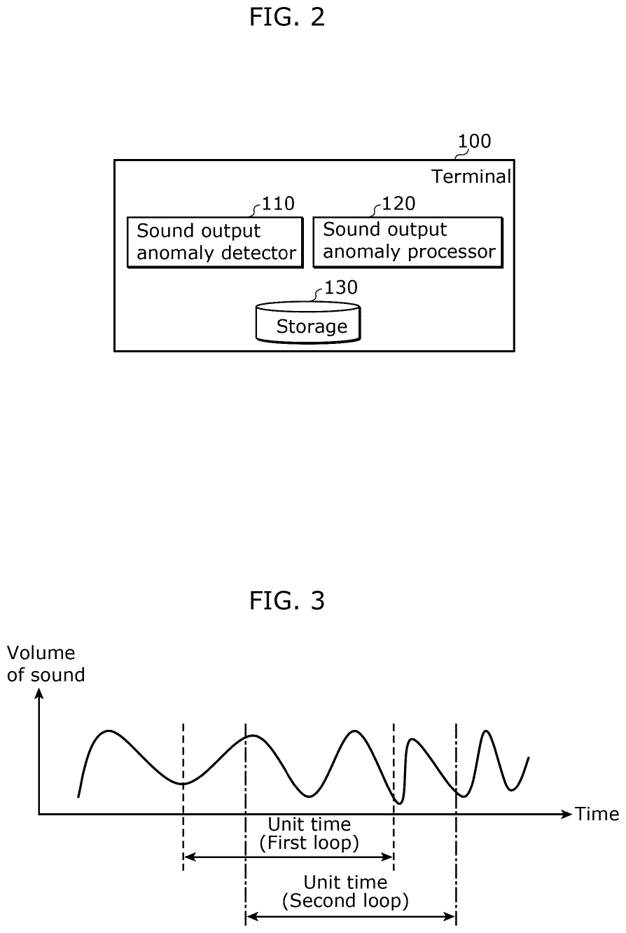

FIG. 2 is a block diagram showing the configuration of terminal 100 in the present embodiment.

Terminal 100 includes sound output anomaly detector 110, sound output anomaly processor 120, and storage 130.

Sound output anomaly detector 110 is a processor which determines, based on the result of detection of the sound output from speaker 20, whether the sound output from speaker 20 is a predetermined sound. Specifically, sound output anomaly detector 110 detects a sound which corresponds to the sound output command transmitted from PC 300 used by the operator located outside vehicle 10 and is output from speaker 20 included in vehicle 10. For example, sound output anomaly detector 110 acquires information indicating a sound detected by microphone 30 to detect the sound corresponding to the sound output command. Furthermore, sound output anomaly detector 110 determines, based on the result of detection of the sound output from speaker 20, whether the sound output from speaker 20 is the predetermined sound. In other words, sound output anomaly detector 110 determines whether speaker 20 outputs the predetermined sound desired by the operator.

Sound output anomaly detector 110 is an example of a detector and a determiner. The sound output command is an example of a command.

For example, in the determination of whether the sound output from speaker 20 is the predetermined sound, sound output anomaly detector 110 determines whether the sound output from speaker 20 is the predetermined sound by comparing the waveform of the sound output from speaker 20 with sound data indicating the waveform of the predetermined sound.

FIG. 3 is a diagram for illustrating anomaly detection processing performed by terminal 100 in the present embodiment. Specifically, FIG. 3 is a graph showing a specific example of the sound detected by microphone 30. The horizontal axis of the graph shown in FIG. 3 indicates time, and the vertical axis indicates the volume of the sound detected by microphone 30.

In storage 130, for example, sound data indicating the waveform of the sound corresponding to the sound output command is previously stored. Sound output anomaly detector 110 determines whether the waveform of the sound output from speaker 20 matches the waveform indicated by the sound data stored in storage 130, when they match each other, sound output anomaly detector 110 determines that the sound output from speaker 20 is the predetermined sound, and when they do not match each other, sound output anomaly detector 110 determines that the sound output from speaker 20 is not the predetermined sound.

Sound output anomaly detector 110 compares, for example, the waveform of a sound detected by microphone 30 continuously over a unit time with the waveform of the sound in the sound data stored in storage 130. For example, sound output anomaly detector 110 compares the waveform in the unit time (first loop) shown in FIG. 3 with the waveform of the sound in the sound data stored in storage 130. Here, when sound output anomaly detector 110 determines that these waveforms do not match each other, sound output anomaly detector 110 compares the waveform of a sound slightly after the unit time (first loop) shown in FIG. 3 in the waveform of the sound detected by microphone 30, for example, a waveform in the unit time (second loop) with the waveform of the sound in the sound data stored in storage 130.

Sound output anomaly detector 110 acquires the sound output command transmitted from PC 300, outputs the sound output command to vehicle 10 (more specifically, control device 200), and thereby causes speaker 20 to output the sound corresponding to the sound output command. Here, for example, in the detection of the sound output from speaker 20, sound output anomaly detector 110 detects a sound for a predetermined period after the sound output command is output to vehicle 10 (more specifically, control device 200), and in the detection of whether the sound output from speaker 20 is the predetermined sound, sound output anomaly detector 110 determines, based on the result of the detection of the sound for the predetermined period, whether the sound output from speaker 20 is the predetermined sound. Specifically, for example, sound output anomaly detector 110 repeatedly compares, for a predetermined time, the waveform of the sound in the unit time detected by microphone 30 with the waveform of the sound indicated by the sound data stored in storage 130, until these two waveforms match each other, while slightly displacing the range of a comparison target waveform in the waveform of the sound detected by microphone 30. Sound output anomaly detector 110 determines that the sound output from speaker 20 is not the predetermined sound if these two waveforms do not match each other even when the comparison is repeated for the predetermined time.

The unit time and the predetermined period may be arbitrarily determined, and are not particularly limited. Information indicating the time (period) is previously stored, for example, in storage 130.

Terminal 100 may include a time measurer such as a real time clock (RTC) for measuring time.

Sound output anomaly processor 120 is a processor which performs a predetermined measure based on the result of the detection performed by sound output anomaly detector 110. For example, sound output anomaly processor 120 outputs, to PC 300, the result of the determination of whether the sound output from speaker 20 is the predetermined sound performed by sound output anomaly detector 110. For example, when sound output anomaly detector 110 determines that the sound output from speaker 20 is the predetermined sound, sound output anomaly processor 120 outputs information indicating that the sound output from speaker 20 is the predetermined sound to PC 300, and thereby causes a notification device such as a speaker and/or a display device included in PC 300 to notify the operator of the information indicating that the sound output from speaker 20 is the predetermined sound. On the other hand, for example, when sound output anomaly detector 110 determines that the sound output from speaker 20 is not the predetermined sound, sound output anomaly processor 120 outputs information indicating that the sound output from speaker 20 is not the predetermined sound to PC 300, and thereby causes the notification device included in PC 300 to notify the operator of the information indicating that the sound output from speaker 20 is not the predetermined sound.

For example, sound output anomaly processor 120 outputs proposed information indicating the characteristic of the sound to be output from speaker 20 to PC 300 based on the result of the determination of whether the sound output from speaker 20 is the predetermined sound performed by sound output anomaly detector 110. For example, it is assumed that sound output anomaly detector 110 determines that the waveform of the sound output from speaker 20 does not match the waveform indicated by the sound data stored in storage 130 because there is a difference in the volume of sound (amplitude). In this case, for example, sound output anomaly processor 120 transmits, to PC 300, the proposed information proposing that the sound output command where the volume of sound is changed be output again.

Although the characteristic of the sound is, for example, the volume of the sound, the characteristic of the sound may be the frequency of the sound, the time at which the sound is output, or the like.

For example, sound output anomaly processor 120 controls the state of travel of vehicle 10 based on the result of the determination of whether the sound output from speaker 20 is the predetermined sound performed by sound output anomaly detector 110. For example, when sound output anomaly processor 120 determines that the sound output from speaker 20 is not the predetermined sound, sound output anomaly processor 120 stops vehicle 10 or slows down vehicle 10 and then causes vehicle 10 to continue traveling.

For example, sound output anomaly processor 120 determines, based on the result of the determination of whether the sound output from speaker 20 is the predetermined sound performed by sound output anomaly detector 110, the characteristic of the sound to be output from speaker 20 and/or speaker 21, and outputs the sound in the characteristic determined from speaker 20 and/or speaker 21.

Each of speaker 20 and speaker 21 is an example of a second speaker.

Sound output anomaly processor 120 may determine a measure to be performed according to the state of vehicle 10, the type of obstacle located around vehicle 10 (for example, the type of target such as a pedestrian or another vehicle which prevents the travel of vehicle 10), and the like.

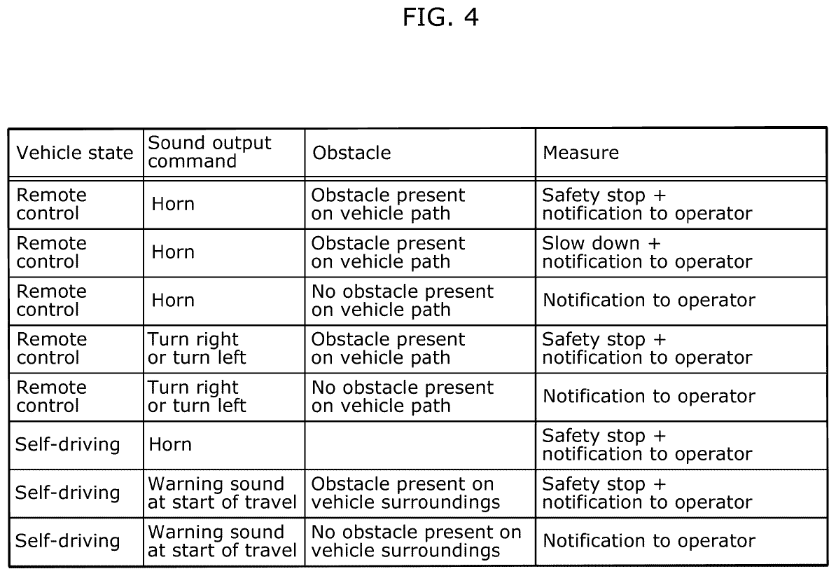

FIG. 4 is a diagram showing specific examples of a measure performed by terminal 100 in the present embodiment. Specifically, FIG. 4 is a table showing specific examples of processing performed by sound output anomaly processor 120 based on the state of vehicle 10, the type of sound output command, and the status of an obstacle. For example, measure information as shown in FIG. 4 is previously stored in storage 130.

The vehicle state is information indicating how vehicle 10 is being controlled to travel (drive). For example, the vehicle state “remote control” indicates that vehicle 10 is being driven by remote control performed by the operator. For example, the vehicle state “self-driving” indicates that vehicle 10 is self-driving.

The sound output command is information indicating the type (content) of sound output command. For example, the sound output command “horn” indicates a command which causes vehicle 10 to blow the horn of vehicle 10. For example, the sound output command “turn right or turn left” indicates a command which causes vehicle 10 to emit a sound when vehicle 10 turns right or left. For example, the sound output command “warning sound at start of travel” indicates a command which causes vehicle 10 to emit a sound when vehicle 10 starts to travel.

The obstacle is an object located on the travel path of vehicle 10 or around vehicle 10. For example, “obstacle present on vehicle path” indicates that an object obstructing the travel of vehicle 10 is located on the travel path of vehicle 10. For example, “obstacle present around vehicle” indicates that an object is located around vehicle 10.

Although the obstacle is, for example, a pedestrian, another vehicle, or the like, the type of obstacle is not particularly limited.

Information indicating the travel path of vehicle 10 and whether an obstacle is located around vehicle 10 may be acquired from control device 200, or may be acquired from PC 300. For example, terminal 100 may acquire the information indicating the travel path of vehicle 10, information indicating the status of the surroundings of vehicle 10 detected by a camera, light detection and ranging (LiDAR), and the like, and the like from control device 200 and/or PC 300 to determine, based on the information described above, the travel path of vehicle 10 and/or whether an obstacle is located around vehicle 10.

For example, when sound output anomaly detector 110 determines that the sound output from speaker 20 is not the predetermined sound, if the vehicle state is “remote control”, the sound output command is “horn”, and the obstacle is “obstacle present on vehicle path”, sound output anomaly processor 120 stops vehicle 10 (“safety stop” shown in FIG. 4), and outputs information indicating that the sound output from speaker 20 is not the predetermined sound (“notification to operator” shown in FIG. 4) to PC 300. In other words, when sound output anomaly detector 110 detects an anomaly, if vehicle 10 is remotely controlled, the predetermined sound is a sound corresponding to the sound output command indicating the “horn”, and an obstacle is located on the travel path of vehicle 10, sound output anomaly processor 120 stops vehicle 10, and notifies PC 300 of an anomaly.

Each of processors such as sound output anomaly detector 110 and sound output anomaly processor 120 is realized, for example, by a memory and a processor such as a central processing unit (CPU) which executes a control program stored in the memory. Sound output anomaly detector 110 and sound output anomaly processor 120 may be realized by the common memory and processor, or may be realized by separate memories and processors.

Storage 130 is a storage device which stores various types of information. Storage 130 stores, for example, the sound data, the measure information, and the like. Storage 130 is realized, for example, by a semiconductor memory, a hard disk drive (HDD), or the like.

Storage 130 may be accessible by control device 200.

Speaker 21 is a speaker which outputs a sound. For example, speaker 21 is disposed in vehicle 10, and outputs a sound to around vehicle 10. For example, speaker 21 serves as an auxiliary to speaker 20. For example, when an anomaly is detected in speaker 20, speaker 21 is controlled to output a sound.

Microphone 30 is a microphone which detects the sound output from speaker 20. Microphone 30 may naturally detect the sound output from speaker 21. Microphone 30 detects, for example, a sound (environment sound) emitted from the surroundings of vehicle 10. For example, sound output anomaly detector 110 detects the environment sound via microphone 30 before the sound corresponding to the sound output command is output from speaker 20. For example, sound output anomaly detector 110 determines, based on the acquired environment sound, whether the sound output from speaker 20 is the predetermined sound.

PC 300 is a computer which is operated by the operator. For example, PC 300 is used by the operator located outside vehicle 10. For example, PC 300 is operated by the operator to transmit the sound output command to vehicle 10 (more specifically, terminal 100).

For example, PC 300 includes: a personal computer including a communication interface for communicating with each device, a nonvolatile memory in which a program is stored, a volatile memory which is a temporary storage region for executing the program, an input/output port for transmitting and receiving signals, a processor for executing the program, and the like; a display device (for example, display device 301 shown in FIG. 8); a notification device; and a user interface such as a mouse and a keyboard which receives an operation performed by the operator. The communication interface may be realized by a connector or the like connected to a control line for wired communication with a base station which wirelessly communicates with terminal 100, or may be realized by a wireless communication circuit for wireless communication with terminal 100. PC 300 may be realized by a tablet terminal or the like.

PC 300 is an example of the remote device.

### [Processing Procedure]

The processing procedure of anomaly detection system 1 will then be described.

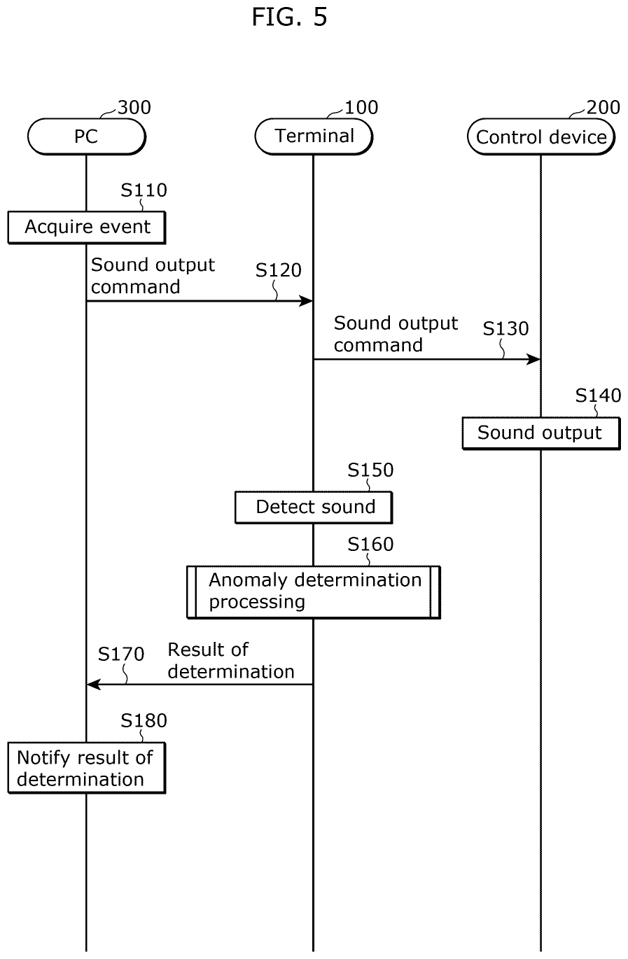

FIG. 5 is a sequence diagram showing the processing procedure of anomaly detection system 1 in the present embodiment.

PC 300 first acquires an event which serves as a trigger for transmitting the sound output command (S110). The type of event may be arbitrarily determined, and is not particularly limited. The event is, for example, that vehicle 10 starts to travel, that vehicle 10 turns right or left, or that an obstacle is located around vehicle 10. For example, the information described above is transmitted from vehicle 10, and PC 300 acquires the event by acquiring the information described above.

PC 300 then outputs the sound output command (S120). Specifically, PC 300 transmits the sound output command corresponding to the acquired event to terminal 100. For example, when the event is that vehicle 10 starts to travel, PC 300 outputs the sound output command which instructs vehicle 10 to output a sound which is determined to output when vehicle 10 starts to travel.

Then, terminal 100 transfers, to control device 200, the sound output command output from PC 300 (S130).

Then, control device 200 causes speaker 20 to output the sound based on the sound output command transferred from terminal 100 (S140). In other words, control device 200 causes speaker 20 to output the sound corresponding to the sound output command.

After transferring the sound output command to control device 200, terminal 100 starts to detect the sound via microphone 30 (S150). In this way, terminal 100 starts to detect (acquire) the sound output from speaker 20.

Then, terminal 100 performs anomaly determination processing (S160). Specifically, terminal 100 determines whether the sound output from speaker 20 is the predetermined sound.

Then, terminal 100 outputs the result of the determination performed in step S160 to PC 300 (S170).

Then, PC 300 uses the notification device to notify the operator of the acquired result of the determination (S180).

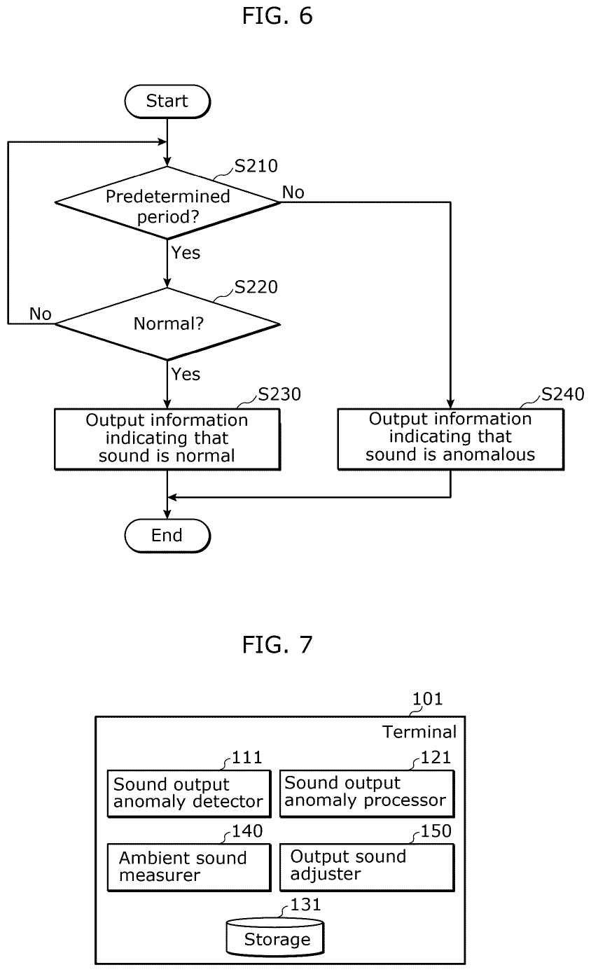

FIG. 6 is a flowchart showing the processing procedure of anomaly detection processing performed by terminal 100 in the present embodiment. Specifically, FIG. 6 is a flowchart showing a specific example of the processing which is performed by sound output anomaly detector 110 and is shown in step S160 in FIG. 5.

Sound output anomaly detector 110 first determines whether a predetermined period has elapsed since the output of the sound output command to control device 200 (S210). Specifically, sound output anomaly detector 110 performs the processing for detecting the sound shown in step S150 in FIG. 5 for the predetermined period. In step S210, sound output anomaly detector 110 determines whether the elapsed time is within the predetermined period for which the processing for detecting the sound is performed.

When sound output anomaly detector 110 determines that the predetermined period has elapsed (yes in S210), sound output anomaly detector 110 determines whether the acquired sound is normal (S220). In other words, sound output anomaly detector 110 determines whether the acquired sound is the predetermined sound.

When sound output anomaly detector 110 determines that the acquired sound is not normal (no in S220), sound output anomaly detector 110 returns the processing to step S210. In other words, sound output anomaly detector 110 repeatedly detects the sound for the predetermined period to determine whether the acquired sound is normal.

When sound output anomaly detector 110 determines that the predetermined period has not elapsed (no in S210), sound output anomaly detector 110 outputs information (result of the determination) indicating an anomaly to PC 300 (S240). In other words, when sound output anomaly detector 110 repeatedly detects the sound for the predetermined period to determine whether the acquired sound is normal, if sound output anomaly detector 110 never determines that the acquired sound is normal, sound output anomaly detector 110 outputs the information indicating an anomaly to PC 300.

On the other hand, when sound output anomaly detector 110 determines that the acquired sound is normal (yes in S220), sound output anomaly detector 110 outputs, to PC 300, information (result of the determination) indicating that the acquired sound is normal (S230). In other words, when the predetermined sound is included in the sound acquired for the predetermined period, sound output anomaly detector 110 outputs, to PC 300, the information indicating that the acquired sound is normal.

### Embodiment 2

Embodiment 2 will then be described. Differences from Embodiment 1 will be mainly described below, and a part or all of repeated description may be omitted or simplified.

FIG. 7 is a block diagram showing the configuration of terminal 101 in the present embodiment.

As with terminal 100, terminal 101 is a computer which acquires the sound output command output from PC 300, and outputs (transfers) the sound output command to control device 200. As with terminal 100, terminal 101 determines whether the sound output from speaker 20 is the predetermined sound, and performs a measure corresponding to the result of the determination.

Terminal 101 includes sound output anomaly detector 111, sound output anomaly processor 121, storage 131, ambient sound measurer 140, and output sound adjuster 150.

Ambient sound measurer 140 is a processor which measures (detects) a sound around vehicle 10 (hereinafter also simply referred to as an ambient sound). For example, ambient sound measurer 140 periodically measures the volume of the ambient sound (for example, a dB value). For example, ambient sound measurer 140 acquires the sound around vehicle 10 via microphone 30.

Vehicle 10 may further include a microphone for detecting the ambient sound other than microphone 30 which detects the sounds output from speakers 20 and 21.

Ambient sound measurer 140 may estimate the volume of the sound around vehicle 10 based on the volume of the ambient sound acquired from microphone 30 and information (sound output map) in which the type of obstacle, the position of the obstacle, and the volume of the sound are associated with each other. The sound output map may be stored in storage 131, or may be transmitted from another device such as PC 300.

Output sound adjuster 150 is a processor which adjusts the volume of the sound to be output from speaker 20 and/or speaker 21. Specifically, output sound adjuster 150 determines the volume of the sound to be output from speaker 20 based on the volume of the ambient sound measured using ambient sound measurer 140, and causes speaker 20 to output the sound corresponding to the sound output command at the determined volume. In other words, output sound adjuster 150 adjusts the volume of the output sound based on the volume of the ambient sound measured using ambient sound measurer 140, and causes speaker 20 and/or speaker 21 to output the sound.

Output sound adjuster 150 may adjust the volume of sound based on the sound output command, or may adjust the volume of sound based on the sound output command and the volume of the ambient sound measured using ambient sound measurer 140. The sound output command may include information indicating the volume of sound. A predetermined volume of sound may be previously determined. For example, output sound adjuster 150 may adjust (change) the volume of sound from the predetermined volume of sound based on the volume of the ambient sound measured using ambient sound measurer 140. Information indicating the predetermined volume of sound may be previously stored in storage 131.

As with sound output anomaly detector 110, sound output anomaly detector 111 is a processor which determines whether the sound output from speaker 20 is the predetermined sound based on the result of the detection of the sound output from speaker 20. In the present embodiment, in the determination of whether the sound output from speaker 20 is the predetermined sound, sound output anomaly detector 111 determines whether the sound output from speaker 20 is the predetermined sound based on the result of the detection of the sound output from speaker 20 and the ambient sound. For example, sound output anomaly detector 111 checks whether the sound output from speaker 20 has the volume of sound adjusted by output sound adjuster 150.

For example, sound output anomaly detector 111 determines, based on obstacle information indicating an obstacle located around vehicle 10, whether the sound output from speaker 20 has reached the obstacle.

The obstacle information is information in which information indicating the type of obstacle and a threshold value for the volume of sound are associated with each other. For example, sound output anomaly detector 111 acquires information indicating the type of obstacle such as a pedestrian or another vehicle located around vehicle 10 based on information (also referred to as sensor information) detected by the camera, the LiDAR, and the like disposed in vehicle 10. Sound output anomaly detector 111 also acquires information indicating the volume of the sound output from speaker 20. For example, the information indicating the volume of the sound is acquired via microphone 30. For example, sound output anomaly detector 111 determines whether the volume of the sound output from speaker 20 is greater than or equal to the threshold value which is included in the obstacle information and is associated with the type of obstacle indicated by the sensor information. When sound output anomaly detector 111 determines that the volume of the sound output from speaker 20 is greater than or equal to the threshold value, sound output anomaly detector 111 determines that the sound output from speaker 20 has reached the obstacle located around vehicle 10. On the other hand, when sound output anomaly detector 111 determines that the volume of the sound output from speaker 20 is less than the threshold value, sound output anomaly detector 111 determines that the sound output from speaker 20 has not reached the obstacle located around vehicle 10. As described above, for example, sound output anomaly detector 111 may determine whether the sound output from speaker 20 has reached the obstacle based on the obstacle information and the sensor information.

In the determination of whether the sound has reached the obstacle, a distance between vehicle 10 and the obstacle may be considered. For example, the sensor information may include information indicating the distance between vehicle 10 and the obstacle. The obstacle information may include information indicating the type of obstacle and information indicating a relationship between the threshold value for the volume of sound and the distance.

Sound output anomaly detector 111 is an example of a detector and a determiner.

Sound output anomaly processor 121 is a processor which performs a predetermined measure based on the result of the detection performed by sound output anomaly detector 110. For example, when the sound output from speaker 20 does not have the volume of sound adjusted by output sound adjuster 150, sound output anomaly processor 121 transmits information indicating an anomaly to PC 300.

For example, sound output anomaly processor 121 outputs, to PC 300, the result of the determination of whether the sound has reached the obstacle performed by sound output anomaly detector 111. Sound output anomaly processor 121 may transmit the obstacle information together with the result of the determination of whether the sound has reached the obstacle performed by sound output anomaly detector 111.

FIG. 8 is a diagram showing a specific example of an image displayed on display device 301 included in PC 300 in the present embodiment. In the example shown in FIG. 8, a case where a pedestrian and another vehicle are present as obstacles located around vehicle 10 is shown.

For example, on display device 301, an image taken by a camera disposed in vehicle 10 is displayed. For example, the image is transmitted by sound output anomaly processor 121 to PC 300 together with the result of the determination performed by sound output anomaly detector 111. For example, it is assumed that sound output anomaly detector 111 determines that the sound output from speaker 20 has reached the pedestrian, and sound output anomaly detector 111 determines that the sound output from speaker 20 has not reached the vehicle. For example, sound output anomaly processor 121 transmits the result of the determination described above, the image of the camera, and information indicating the corresponding obstacle to PC 300. In this way, in such a case, for example, the image including image 310 and image 311 is displayed on display device 301. In image 310, the result of the determination such as “alert OK” performed by sound output anomaly detector 111 is shown, and the pedestrian which the sound output from speaker 20 has reached is included. In image 311, the result of the determination such as “alert NG” performed by sound output anomaly detector 111 is shown, and the vehicle which the sound output from speaker 20 has not reached is included.

Storage 131 is a storage device which stores various types of information. Storage 131 stores, for example, the sound data, the measure information, and the like. Storage 131 also stores, for example, the obstacle information. Storage 131 is realized, for example, by a semiconductor memory, an HDD, or the like.

FIG. 9 is a flowchart showing the processing procedure of terminal 101 in the present embodiment.

Terminal 101 first transmits (transfers) the sound output command acquired from PC 300 to vehicle 10 (more specifically, control device 200) (S310).

Then, terminal 101 detects the sound via microphone 30 (S320). For example, sound output anomaly detector 111 detects the sound via microphone 30.

Then, terminal 101 determines whether an obstacle located around vehicle 10 can be alerted (S330). Specifically, sound output anomaly detector 111 determines whether the sound output from speaker 20 has reached the obstacle based on the obstacle information indicating the obstacle located around vehicle 10.

Sound output anomaly detector 111 determines whether the sound output from speaker 20 is the predetermined sound based on the result of the detection of the sound output from speaker 20, and when sound output anomaly detector 111 determines that the sound output from speaker 20 is not the predetermined sound, sound output anomaly detector 111 may determine that the sound output from speaker 20 has not reached the obstacle.

In step S320, ambient sound measurer 140 may further measure the sound around vehicle 10. In step S330, sound output anomaly detector 111 may determine whether the sound output from speaker 20 has reached the obstacle based on the volume of the ambient sound.

Then, terminal 101 (more specifically, sound output anomaly processor 121) outputs (transmits) the result of the determination performed by sound output anomaly detector 111 to PC 300 (S340). In this way, for example, on display device 301 included in PC 300, the image showing the result of the determination performed by sound output anomaly detector 111 as shown in FIG. 8 is displayed.

### Variations

The configuration of the anomaly detection system in the present disclosure is not limited to the configurations described above. Variations of the anomaly detection system in the present disclosure will be described below.

As described above, even if vehicle 10 can output a sound, the anomaly detection system in the present disclosure determines whether the sound has reached the target of the sound. For example, when terminal 100 determines that the sound has not reached the target of the sound (for example, when terminal 100 determines that the sound output from speaker 20 is not the predetermined sound), terminal 100 may assist vehicle 10 in determining whether vehicle 10 outputs a sound again. For example, when terminal 100 determines that the sound has not reached the target of the sound, terminal 100 may output an instruction to control device 200 to cause speaker 20 and/or speaker 21 to output a sound (one-shot sound) for an operation of vehicle 10 such as “starting to travel” or an alert such as “starting to pass” to a person located around vehicle 10. In this way, for example, it is possible to reliably alert the person located around vehicle 10.

For example, the sound output of “starting to travel” or the like described above is performed when terminal 100 determines that the sound output from speaker 20 is not the predetermined sound. For example, when a target such as a person is not located near a mobile object such as vehicle 10, terminal 100 may present information indicating that the sound output does not need to be performed again to display device 301. On the other hand, for example, when the target such as a person is located near the mobile object such as vehicle 10, terminal 100 may present information indicating that the sound output is encouraged to be performed again to display device 301. For example, in this case, terminal 100 may produce, on display device 301, a display for allowing the operator to recognize which is the target such as a person causing the sound output to be performed again together with the information indicating that the sound output is encouraged to be performed again. In this way, the operator can easily determine whether the mobile object is caused to perform the sound output again.

Although the mobile object is, for example, vehicle 10, the mobile object may be a robot or the like. The mobile object may include a sensor such as a camera to identify the target. For example, the mobile object may include a display for displaying a video and/or a light emitting device such as a light emitting diode (LED). For example, when terminal 100 acquires an instruction from the operator to perform the sound output again, terminal 100 may cause the mobile object to present an alert or the like to the target using an output device capable of outputting light or the like caused by a display and/or an LED other than sound. Here, terminal 100 may cause the mobile object to present an alert or the like using the method other than sound together with sound, or may cause the mobile object to present an alert or the like using only the method other than sound without outputting a sound. The mobile object is caused to present an alert or the like using only the method other than sound without outputting a sound, and thus it is possible to reduce annoyance felt by the target due to the repetition of the same content.

For example, terminal 100 may cause the mobile object to output words (sound) of the operator without the words being processed instead of performing the sound output again. PC 300 may include a microphone for detecting the sound of the operator. For example, terminal 100 may acquire information indicating the sound described above from PC 300 to cause speaker 20 and/or speaker 21 to output the acquired information indicating the sound. In this way, the operator can appropriately alert the target using the words of the operator depending on the situation. For example, terminal 100 may cause the mobile object to output a message different from the sound message which has been output instead of performing the sound output again.

For example, when terminal 100 determines that the sound output from speaker 20 is not the predetermined sound, it may be dangerous to stop the travel of vehicle 10.

Hence, for example, when the sound output from speaker 20 is not the predetermined sound, terminal 100 may cause speaker 20 to repeatedly output the same sound without stopping vehicle 10. In other words, when the sound output from speaker 20 is not the predetermined sound, terminal 100 may cause vehicle 10 to repeatedly output the same sound such as “turning right (or left)”, “machine sound (for example, when vehicle 10 moves backward)”, or “go ahead” as a loop.

For example, when the sound output of “turning right (or left)” is not the predetermined sound, and thus vehicle 10 stops on the spot, vehicle 10 may cause a disturbance to other traffic participants. On the other hand, for example, when vehicle 10 is a self-driving vehicle, and thus vehicle 10 autonomously move without being disturbed, this may cause other traffic participants located around vehicle 10 to be in danger.

Here, for example, in a case where the content of the sound output from speaker 20 is “turning right (or left)”, when terminal 100 determines that the sound output from speaker 20 is not the predetermined sound, terminal 100 may make an attention request to the operator. For example, terminal 100 may output, to PC 300, information (attention request information) for requesting the operator to direct visual attention to vehicle 10. Specifically, when terminal 100 determines that the sound output from speaker 20 is not the predetermined sound, terminal 100 may output the attention request information for prompting the operator to direct visual attention to vehicle 10 to PC 300 used by the operator located outside vehicle 10.

In this way, since vehicle 10 can be caused to autonomously travel while the operator is gazing at vehicle 10, when other traffic participants may be in danger, the operator can remotely intervene and stop vehicle 10.

For example, when terminal 100 requests the operator to direct visual attention to vehicle 10, terminal 100 may also notify the operator of the content of the sound output indicating what is output in the sound output. For example, terminal 100 outputs, to PC 300, the information (content information) indicating the content of the sound output indicating what is output in the sound output together with the attention request. Specifically, when terminal 100 determines that the sound output from speaker 20 is not the predetermined sound, terminal 100 may further output the content information indicating the content of the sound output from speaker 20 to PC 300. This makes it clear what the operator needs to be careful about.

In the loop of the sound output described above (also referred to as loop processing), for example, terminal 100 may determine whether the sound output from speaker 20 is the predetermined sound each time the loop processing is performed. When in the determination made each time the loop processing is performed, terminal 100 continuously determines that the sound output from speaker 20 is not the predetermined sound, terminal 100 may make a notification to the operator. In the loop processing described above, even when terminal 100 once determines that the sound output from speaker 20 is not the predetermined sound, if terminal 100 subsequently determines that the sound output from speaker 20 is the predetermined sound, it can be considered that the sound can appropriately notified to the target, that is, the sound has reached the target.

For example, in a case where in the loop processing, the mobile object outputs a sound three times, that is, outputs “starting to pass, starting to pass, starting to pass”, even when the first “starting to pass” has not reached the target satisfactorily, that is, even when terminal 100 determines that the first “starting to pass” is not the predetermined sound, if the second or third “starting to pass” has reached the target satisfactorily, that is, terminal 100 determines that the second or third “starting to pass” is the predetermined sound, it can be considered that there is no problem.

For example, when the mobile object outputs the sound while moving, if a communication delay occurs, the mobile object outputs the sound in a position different from the intended position. In this case, a contradiction may occur between the content of the sound output and the content of the control.

Hence, for example, in a case where vehicle 10 is caused to output a sound of “starting to pass”, when vehicle 10 is stopped for safety stop or the like during the period until vehicle 10 outputs the sound after PC 300 transmits a sound output command indicating an instruction to cause vehicle 10 to output the sound of “starting to pass”, if vehicle 10 receives the sound output command, and there is a contradiction between the content of the sound output included in the sound output command and the state of vehicle 10, vehicle 10 performs control such that vehicle 10 does not output the sound. Specifically, when the content of the sound output indicates the travel of vehicle 10 such as “starting to pass”, if vehicle 10 is in a state such as an emergency stop where vehicle 10 does not travel, vehicle 10 determines that there is a contradiction between the content of the sound output and the state of vehicle 10. A criterion for determining whether the contradiction occurs may be arbitrarily determined.

As described above, for example, when terminal 100 acquires state information indicating the state of vehicle 10, and acquires the sound output command transmitted from PC 300 used by the operator located outside vehicle 10, terminal 100 determines, based on the state information and the sound output command, whether the sound corresponding to the sound output command is output from speaker 20. For example, when there is no contradiction between the state of vehicle 10 and the content of the sound output command based on the state information and the sound output command, terminal 100 outputs the sound based on the sound output command from speaker 20, and when there is a contradiction between the state of vehicle 10 and the content of the sound output command, terminal 100 does not output the sound based on the sound output command from speaker 20. The state information is information which indicates the state of vehicle 10 such as traveling straight, stopping, or turning left or right. The information described above may be acquired from various types of sensors included in vehicle 10 such as a speed sensor which detects the speed of vehicle 10, an acceleration sensor which detects the acceleration of vehicle 10, and a steering angle sensor which detects the steering angle of vehicle 10.

Then, specific configurations of the variations of the anomaly detection system in the present disclosure will be described. Differences from Embodiments 1 and 2 will be mainly described below, and a part or all of repeated description may be omitted or simplified.

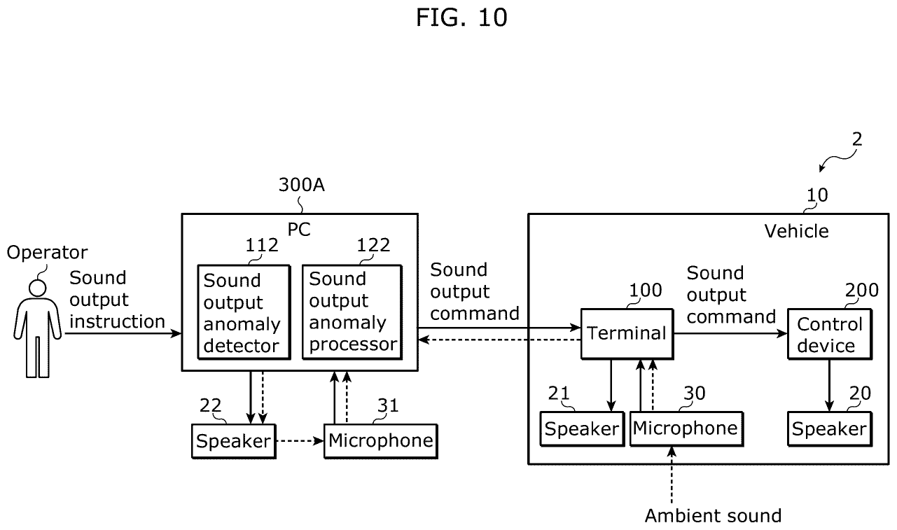

FIG. 10 is a block diagram showing the configuration of anomaly detection system 2 in Variation 1.

Anomaly detection system 2 includes vehicle 10, PC 300A, speaker 22, and microphone 31. In anomaly detection system 2, for example, PC 300A detects whether the sound output from speaker 20 is anomalous. Specifically, PC 300A determines whether the sound output from speaker 20 is the predetermined sound.

For example, PC 300A acquires, from terminal 100, sound data (for example, voice data) indicating a sound (for example, a voice) such as an ambient sound detected by microphone 30, and causes speaker 22 connected to PC 300A to output the sound based on the acquired voice data. The sound output in this way is detected by microphone 31, and thus PC 300A compares voice data indicating the sound detected by microphone 31 with the sound output from speaker 22 (specifically, the voice data indicating the sound output from speaker 22) to determine whether the output sound is anomalous. For example, when PC 300A determines that the output sound is anomalous, PC 300A notifies the operator of the result of the determination indicating that the output sound is anomalous. Specifically, terminal 100 uses microphone 30 included in vehicle 10 to detect the ambient sound of vehicle 10, and outputs sound data indicating the detected ambient sound of vehicle 10 to PC 300A used by the operator located outside vehicle 10. PC 300A detects the sound based on the sound data output from speaker 22 connected to PC 300A using microphone 31 connected to PC 300A, and determines, based on the sound detected using microphone 31 and the sound data, whether the sound output from speaker 22 is anomalous. Microphone 30 is an example of a first microphone. PC 300A is an example of a remote device. Speaker 22 is an example of a third speaker. Microphone 31 is an example of a second microphone. For example, in the determination of whether the sound output from speaker 22 is anomalous, PC 300A determines whether the sound output from speaker 22 is the same as the predetermined sound. The predetermined sound determined here may be arbitrarily determined, and is not particularly limited. The predetermined sound determined here may be the same as or different from the predetermined sound used in the determination of the sound output from speaker 20 and/or speaker 21.

PC 300A includes sound output anomaly detector 112 and sound output anomaly processor 122.

Sound output anomaly detector 112 is a processor which determines whether the sound output from speaker 20 is the predetermined sound based on the result of the detection of the sound output from speaker 20. Specifically, sound output anomaly detector 112 acquires sound data indicating the sound from terminal 100 which detects the sound output from speaker 20 included in vehicle 10, and determines, based on the acquired sound data, whether the sound output from speaker 20 is the predetermined sound. In other words, sound output anomaly detector 112 determines whether the predetermined sound desired by the operator is output from speaker 20.

Specifically, sound output anomaly detector 112 outputs the sound indicated by the acquired sound data from speaker 22. Furthermore, sound output anomaly detector 112 acquires the sound data indicating the sound from microphone 31 which detects the sound output from speaker 22. Furthermore, sound output anomaly detector 112 determines, based on the sound data, whether the sound output from speaker 20 is the predetermined sound.

PC 300A includes a storage in which sound data indicating the waveform of the sound corresponding to the sound output command is previously stored. The storage is realized, for example, by an HDD, an SDD, or the like. For example, as with sound output anomaly detector 110, sound output anomaly detector 112 determines whether the waveform of the sound output from speaker 20 matches the waveform indicated by the sound data stored in the storage, when they match each other, sound output anomaly detector 112 determines that the sound output from speaker 20 is the predetermined sound, and when they do not match each other, sound output anomaly detector 112 determines that the sound output from speaker 20 is not the predetermined sound.

Sound output anomaly detector 112 is an example of a detector and a determiner.

Sound output anomaly processor 122 is a processor which performs a predetermined measure based on the result of the detection performed by sound output anomaly detector 112. For example, sound output anomaly processor 122 presents the result of the determination of whether the sound output from speaker 20 is the predetermined sound performed by sound output anomaly detector 112 to the operator using display device 301 included in PC 300 or the like.

Each of processors such as sound output anomaly detector 112 and sound output anomaly processor 122 is realized, for example, by a processor such as a CPU and a memory in which a control program to be executed by the processor is recorded.

As described above, constituent elements included in the anomaly detection system in the present disclosure may be included in any one of the PC, the terminal, and the control device.

When PC 300A includes sound output anomaly detector 112 and sound output anomaly processor 122, terminal 100 may include sound output anomaly detector 110 and sound output anomaly processor 120, or does not need to include sound output anomaly detector 110 and sound output anomaly processor 120.

Sound output anomaly detector 112 and sound output anomaly processor 122 included in PC 300A may perform processing to be performed by sound output anomaly detector 110 and sound output anomaly processor 120, and may perform processing to be performed by sound output anomaly detector 111 and sound output anomaly processor 121. PC 300A may include a processor which performs processing to be performed by ambient sound measurer 140 and output sound adjuster 150.

FIG. 11 is a block diagram showing the configuration of anomaly detection system 3 in Variation 2.

Anomaly detection system 3 includes vehicle 10, PC 300, and speaker 23. In anomaly detection system 3, an anomaly in a sound output from speaker 23 disposed in a location different from vehicle 10 is detected.

Speaker 23 is installed, for example, at the entrance of a building such as a factory. In the present example, it is assumed that the sound is output from speaker 23, and a target around speaker 23 is alerted. For example, when vehicle 10 is in a predetermined situation, such as moving from inside to outside of the factory, or moving from outside to inside of the factory, speaker 23 outputs a sound to alert a person located around speaker 23. For example, terminal 100 performs anomaly determination on voice data indicating the sound output from speaker 23 (determination of whether the sound output from speaker 23 is the predetermined sound), and when terminal 100 determines that the voice data is anomalous (that is, when terminal 100 determines that the sound output from speaker 23 is not the predetermined sound), terminal 100 notifies the operator of the anomaly.

As described above, terminal 100 determines whether not only the sound output from speaker 20 but also a sound output from a speaker (for example, speaker 23) other than speaker 20 is the predetermined sound. For example, furthermore, terminal 100 detects a sound output from speaker 23 disposed outside vehicle 10, and determines whether the sound output from speaker 23 is anomalous based on the result of the detection of the sound output from speaker 23. Speaker 23 is an example of a fourth speaker.

In this way, terminal 100 can determine whether a sound detected around vehicle 10 is anomalous.

The predetermined sound used in the determination of the sound output from speaker 20 included in vehicle 10 and the predetermined sound used in the determination of the sound output from speaker 23 disposed outside vehicle 10 may be the same as or different from each other. Although the predetermined sound is indicated, for example, by the sound data indicating the waveform, the predetermined sound may be indicated by data indicating the volume of sound, the pressure of sound, the frequency of sound, or the like.

### Outline

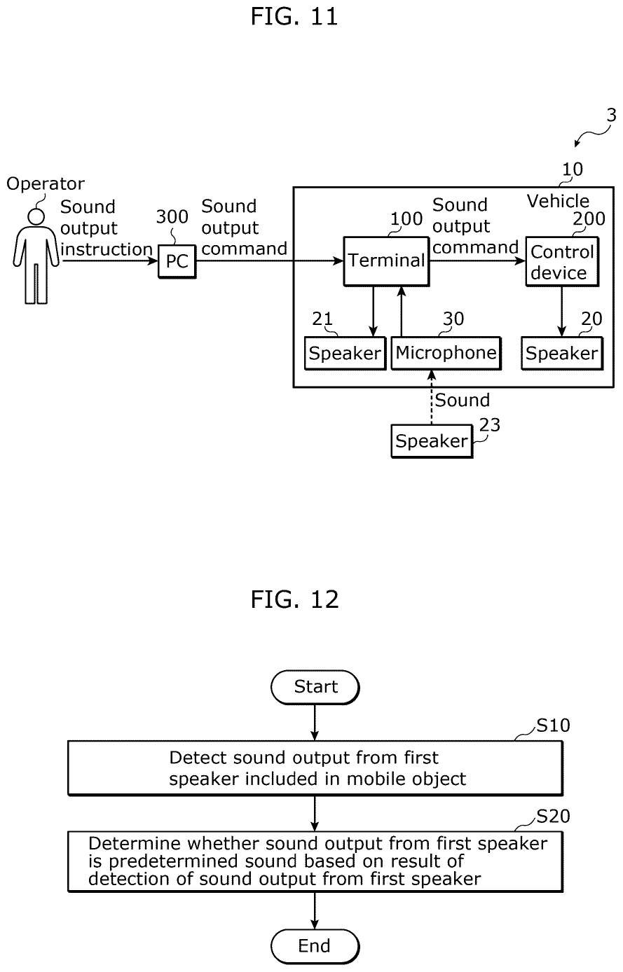

FIG. 12 is a flowchart showing the processing procedure of an information processing device according to an aspect of the present disclosure. The information processing device is, for example, terminal 100 or terminal 101. The information processing device may be realized by any combination of the configurations and the processing of terminal 100 and terminal 101.

The information processing device first detects a sound output from a first speaker included in a mobile object (S10).

Then, the information processing device determines whether the sound output from the first speaker is the predetermined sound based on the result of the detection of the sound output from the first speaker (S20).

The information processing device includes, for example, a processor and a memory, and the processor uses the memory to perform the processing described above.

### Effects and Like

Techniques obtained from the details of the disclosure of the present specification will be illustrated, and effects and the like obtained from the illustrated techniques will be described.

Technique 1 is an information processing method that includes: detecting a sound output from a first speaker included in a mobile object (S10); and determining whether the sound output from the first speaker is a predetermined sound based on a result of the detecting of the sound output from the first speaker (S20).

The mobile object is, for example, vehicle 10.

The mobile object may be any object capable of traveling, and may be, for example, a motorcycle, a robot, or the like.

The remote device is, for example, PC 300.

The command is, for example, the sound output command described above.

The first speaker is, for example, speaker 20.

In this way, for example, it is possible to detect that the first speaker is faulty, and thus the predetermined sound is not output. Since the sound output from the first speaker is detected, and whether the sound output from the first speaker is the predetermined sound is determined, it is possible to detect a state where even when the sound is output from the first speaker, for example, the volume of a sound around the mobile object is large, and thus the sound output from the first speaker has not appropriately reached a target such as a pedestrian or another vehicle. Hence, in the information processing method according to the embodiment, it is possible to determine whether an appropriate sound is output from a speaker (first speaker). In other words, it is possible to determine whether the sound is output from a speaker to appropriately reach the target.

Technique 2 is the information processing method described in technique 1 where in the determining of whether the sound output from the first speaker is the predetermined sound, whether the sound output from the first speaker is the predetermined sound is determined by comparing a waveform of the sound output from the first speaker with sound data indicating a waveform of the predetermined sound.

In this way, it is possible to easily determine whether the sound output from the first speaker is the predetermined sound.

Technique 3 is the information processing method described in technique 1 or 2 where by acquiring a command transmitted from a remote device used by an operator located outside the mobile object and outputting the command to the mobile object, a sound corresponding to the command is output from the first speaker, in the detecting of the sound output from the first speaker, the sound is detected for a predetermined period after the command is output to the mobile object, and in the determining of whether the sound output from the first speaker is the predetermined sound, whether the sound output from the first speaker is the predetermined sound is determined based on a result of the detecting of the sound for the predetermined period.

When the mobile object (more specifically, control device 200 which controls devices such as speaker 20 included in vehicle 10) acquires the command, the mobile object outputs the sound corresponding to the command from the first speaker. Hence, the sound corresponding to the command can be output from the first speaker, for example, within the predetermined period after the command is output to the mobile object. Thus, for example, when a long time has elapsed since the output of the command to the mobile object, the sound corresponding to the command is not output from the first speaker. Consequently, it is found that when the predetermined sound is not detected for the predetermined period, the sound corresponding to the command is not appropriately output from the first speaker. Therefore, in this way, it is possible to appropriately determine whether the sound output from the first speaker is the predetermined sound.

Technique 4 is the information processing method described in any one of techniques 1 to 3 that further includes: detecting a sound around the mobile object, and in the determining of whether the sound output from the first speaker is the predetermined sound, whether the sound output from the first speaker is the predetermined sound is determined based on a result of the detecting of the sound output from the first speaker and the sound around the mobile object.

In this way, it is possible to appropriately determine whether the detected sound includes the predetermined sound even if the sound around the detected sound is included as noise.

Technique 5 is the information processing method described in any one of techniques 1 to 4 that further includes: outputting a result of the determining of whether the sound output from the first speaker is the predetermined sound to a remote device used by an operator located outside the mobile object.

In this way, the operator who is not located in the mobile object can grasp whether the predetermined sound is appropriately output from the first speaker.

Technique 6 is the information processing method described in any one of techniques 1 to 5 that further includes: outputting, based on a result of the determining of whether the sound output from the first speaker is the predetermined sound, proposed information indicating a characteristic of a sound to be output from the first speaker to a remote device used by an operator located outside the mobile object.

For example, when the volume of the sound around the mobile object is large, and thus the sound output from the first speaker has not appropriately reached the target, the volume of the sound output from the first speaker may be increased. Hence, in such a case, for example, proposed information including a proposal for increasing the volume of the sound is output to the remote device, and thus the proposal is notified to the operator. In this way, the operator can easily grasp how the sound corresponding to the command can be caused to appropriately reach the target.

Technique 7 is the information processing method described in any one of techniques 1 to 6 that further includes: controlling a state of travel of the mobile object based on a result of the determining of whether the sound output from the first speaker is the predetermined sound.

The sound output from the first speaker includes, for example, a warning sound for a pedestrian or the like located around the mobile object. Hence, when such a warning sound is not appropriately output from the first speaker, the pedestrian or the like may be in danger. Therefore, for example, when the sound output from the first speaker is determined not to be the predetermined sound, the mobile object is stopped or slowed down. In this way, it is possible to enhance the safety of the travel of the mobile object.

Technique 8 is the information processing method described in any one of techniques 1 to 7 that further includes: determining, based on a result of the determining of whether the sound output from the first speaker is the predetermined sound, a characteristic of a sound to be output from a second speaker, and causing the second speaker to output the sound in the characteristic determined.

The second speaker is, for example, speaker 21.

The second speaker may be speaker 20. In other words, the second speaker may be the first speaker, or may be a speaker different from the first speaker.

In this way, when the volume of the sound around the mobile object is large, and thus the sound output from the first speaker has not appropriately reached the target, it is possible to cause the sound output from the first speaker to easily reach the target, for example, by increasing the volume of the sound. When the second speaker is a speaker different from the first speaker, even if the first speaker is faulty, the sound corresponding to the command can be output from the second speaker.

Technique 9 is the information processing method described in any one of techniques 1 to 8 that further includes: determining, based on obstacle information indicating an obstacle located around the mobile object, whether the sound output from the first speaker has reached the obstacle; and outputting a result of the determining of whether the sound output from the first speaker has reached the obstacle to a remote device used by an operator located outside the mobile object.

In this way, the operator can easily grasp whether the sound output from the first speaker has appropriately reached the obstacle.

Technique 10 is the information processing method described in any one of techniques 1 to 9 that further includes: outputting attention request information for prompting an operator to direct visual attention to the mobile object to a remote device used by the operator located outside the mobile object when the sound output from the first speaker is determined not to be the predetermined sound.

In this way, since the mobile object can be caused to autonomously travel while the operator is gazing at the mobile object, when other traffic participants located around the mobile object may be in danger, the operator can remotely intervene and stop the mobile object.

Technique 11 is the information processing method described in technique 10 that further includes: outputting, to the remote device, content information indicating a content of the sound output from the first speaker when the sound output from the first speaker is determined not to be the predetermined sound.

This makes it clear what the operator needs to be careful about.

Technique 12 is the information processing method described in any one of techniques 1 to 11 that further includes: detecting a sound around the mobile object using a first microphone included in the mobile object; outputting sound data indicating the sound around the mobile object that has been detected to a remote device used by an operator located outside the mobile object; detecting, using a second microphone connected to the remote device, a sound that is output from a third speaker connected to the remote device and is based on the sound data; and determining whether the sound output from the third speaker is anomalous based on the sound detected using the second microphone and the sound data.

The first microphone is, for example, microphone 30 described above. The remote device described here is, for example, PC 300A. The third speaker is, for example, speaker 22 described above. The second microphone is, for example, microphone 31 described above. In the determining of whether the sound output from the third speaker is anomalous, for example, whether the sound is the same as the predetermined sound is determined.

In this way, it is possible to determine whether a sound from outside the first speaker included in the mobile object is anomalous.

Technique 13 is the information processing method described in any one of techniques 1 to 12 that further includes: detecting a sound output from a fourth speaker disposed outside the mobile object; and determining whether the sound output from the fourth speaker is anomalous based on a result of the detecting of the sound output from the fourth speaker.

The fourth speaker is, for example, speaker 23. In the determining of whether the sound output from the fourth speaker is anomalous, for example, whether the sound is the same as the predetermined sound is determined.

In this way, it is possible to determine whether a sound from outside the first speaker included in the mobile object is anomalous.

Technique 14 is the information processing method described in any one of techniques 1 to 13 that further includes: acquiring state information indicating a state of the mobile object, and when a command transmitted from a remote device used by an operator located outside the mobile object is acquired, whether a sound corresponding to the command is output from the first speaker is determined based on the state information and the command.

In this way, for example, when there is a contradiction between the content of the sound corresponding to the command (content of the sound output) and the state of the mobile object, the sound corresponding to the command is prevented from being output from the first speaker, and thus it is possible to suppress of a misunderstanding made by other traffic participants and the like located around the mobile object due to the sound corresponding to the command.

Technique 15 is an information processing device that includes: a detector that detects a sound output from a first speaker included in a mobile object; and a determiner that determines whether the sound output from the first speaker is a predetermined sound based on a result of the detecting of the sound output from the first speaker.

The information processing device is, for example, terminal 100 or terminal 101. The detector and the determiner are realized, for example, by sound output anomaly detector 110 or sound output anomaly detector 111.

In this way, the same effects as the information processing method according to the embodiment are achieved.

Technique 16 is the information processing device described in technique 15, and the information processing device is disposed in the mobile object.

In this way, for example, as compared with a case where the information processing device is disposed outside the mobile object together with the remote device, more reliable communication between the information processing device and the mobile object can be ensured. Hence, the mobile object can be caused to more reliably perform processing which is performed by the mobile object such as stopping the mobile object when the sound output from the first speaker is determined not to be the predetermined sound.

Technique 17 is a program for causing a computer to execute the information processing method described in any one of techniques 1 to 14.

In this way, the same effects as the information processing method according to the embodiment are achieved.

### Other Embodiments

Although the embodiments have been described above, the present disclosure is not limited to the embodiments and variations described above.

For example, in the embodiment described above, processing which is performed by a specific processor may be performed by another processor. The order of a plurality of processing steps may be changed, or a plurality of processing steps may be performed in parallel.

In the embodiment described above, each of constituent elements (processors) may be realized by executing a software program suitable for the corresponding constituent element. A program executor such as a central processing unit (CPU) or a processor may read and execute a software program recorded in a recoding medium such as a hard disk or a semiconductor memory to realize each of the constituent elements.

The constituent elements may be realized by hardware. The constituent elements may be circuits (or an integrated circuit). These circuits may from one circuit as a whole, or may be separate circuits. These circuits may be general-purpose circuits or may be dedicated circuits.

General or specific aspects of the present disclosure may be realized by a system, a device, a method, an integrated circuit, a computer program, or a non-transitory computer-readable recording medium such as a CD-ROM. The general or specific aspects may be realized by any combination of a system, a device, a method, an integrated circuit, a computer program, and a recording medium.

Embodiments obtained by performing various variations conceived by those skilled in the art on the embodiments and variations and embodiments realized by arbitrarily combining the constituent elements and functions in the embodiments and variations without departing from the spirit of the present disclosure are also included in the present disclosure.

### Industrial Applicability

The present disclosure can be utilized in a device which is installed in a vehicle and detects an anomaly in a speaker included in the vehicle.

1. An information processing method comprising:
detecting a sound output from a first speaker included in a mobile object; and
determining whether the sound output from the first speaker is a predetermined sound based on a result of the detecting of the sound output from the first speaker.

2. The information processing method according to claim 1,
wherein in the determining of whether the sound output from the first speaker is the predetermined sound, whether the sound output from the first speaker is the predetermined sound is determined by comparing a waveform of the sound output from the first speaker with sound data indicating a waveform of the predetermined sound.

3. The information processing method according to claim 1,
wherein by acquiring a command transmitted from a remote device used by an operator located outside the mobile object and outputting the command to the mobile object, a sound corresponding to the command is output from the first speaker,
in the detecting of the sound output from the first speaker, the sound is detected for a predetermined period after the command is output to the mobile object, and
in the determining of whether the sound output from the first speaker is the predetermined sound, whether the sound output from the first speaker is the predetermined sound is determined based on a result of the detecting of the sound for the predetermined period.

4. The information processing method according to claim 1, further comprising:
detecting a sound around the mobile object,
wherein in the determining of whether the sound output from the first speaker is the predetermined sound, whether the sound output from the first speaker is the predetermined sound is determined based on a result of the detecting of the sound output from the first speaker and the sound around the mobile object.

5. The information processing method according to claim 1, further comprising:
outputting a result of the determining of whether the sound output from the first speaker is the predetermined sound to a remote device used by an operator located outside the mobile object.

6. The information processing method according to claim 1, further comprising:
outputting, based on a result of the determining of whether the sound output from the first speaker is the predetermined sound, proposed information indicating a characteristic of a sound to be output from the first speaker to a remote device used by an operator located outside the mobile object.

7. The information processing method according to claim 1, further comprising:
controlling a state of travel of the mobile object based on a result of the determining of whether the sound output from the first speaker is the predetermined sound.

8. The information processing method according to claim 1, further comprising:
determining, based on a result of the determining of whether the sound output from the first speaker is the predetermined sound, a characteristic of a sound to be output from a second speaker, and causing the second speaker to output the sound in the characteristic determined.

9. The information processing method according to claim 1, further comprising:
determining, based on obstacle information indicating an obstacle located around the mobile object, whether the sound output from the first speaker has reached the obstacle; and
outputting a result of the determining of whether the sound output from the first speaker has reached the obstacle to a remote device used by an operator located outside the mobile object.

10. The information processing method according to claim 1, further comprising:
outputting attention request information for prompting an operator to direct visual attention to the mobile object to a remote device used by the operator located outside the mobile object when the sound output from the first speaker is determined not to be the predetermined sound.

11. The information processing method according to claim 10, further comprising:
outputting, to the remote device, content information indicating a content of the sound output from the first speaker when the sound output from the first speaker is determined not to be the predetermined sound.

12. The information processing method according to claim 1, further comprising:
detecting a sound around the mobile object using a first microphone included in the mobile object;
outputting sound data indicating the sound around the mobile object that has been detected to a remote device used by an operator located outside the mobile object;
detecting, using a second microphone connected to the remote device, a sound that is output from a third speaker connected to the remote device and is based on the sound data; and
determining whether the sound output from the third speaker is anomalous based on the sound detected using the second microphone and the sound data.

13. The information processing method according to claim 1, further comprising:
detecting a sound output from a fourth speaker disposed outside the mobile object; and
determining whether the sound output from the fourth speaker is anomalous based on a result of the detecting of the sound output from the fourth speaker.

14. The information processing method according to claim 1, further comprising:
acquiring state information indicating a state of the mobile object,
wherein when a command transmitted from a remote device used by an operator located outside the mobile object is acquired, whether a sound corresponding to the command is output from the first speaker is determined based on the state information and the command.

15. An information processing device comprising:
a detector that detects a sound output from a first speaker included in a mobile object; and
a determiner that determines whether the sound output from the first speaker is a predetermined sound based on a result of the detecting of the sound output from the first speaker.

16. The information processing device according to claim 15,
wherein the information processing device is disposed in the mobile object.

17. A non-transitory computer-readable recording medium having recorded thereon a program for causing a computer to execute the information processing method according to claim 1.
